(19) United States
(12) Patent Application Publication
(10) Pub. No.: US 2024/0130369 A1
(43) Pub. Date: Apr. 25, 2024

(54) DURABLE OMNIPHOBIC AND/OR HYDROPHOBIC ANTIMICROBIAL COATING

(71) Applicant: MICROBAN PRODUCTS COMPANY, Huntersville, NC (US)

(72) Inventors: James Marion RAPLEY, Huntersville, NC (US); Angie Johnson, Davidson, NC (US); Craig Lott, Davidson, NC (US)

(21) Appl. No.: 18/382,689

(22) Filed: Oct. 22, 2023

Related U.S. Application Data
(60) Provisional application No. 63/418,718, filed on Oct. 24, 2022.

(51) Int. Cl. A01N 55/00; A01N 25/10; A01P 1/00; C09D 5/14; C09D 5/16; C09D 133/08

(52) U.S. Cl. CPC A01N 55/00; A01N 25/10; A01P 1/00; C09D 5/14; C09D 5/1625; C09D 133/08; C08L 2201/10

(57) ABSTRACT

A liquid composition configured to form a transparent oleophobic and hydrophobic antimicrobial coating after application and post-cure of the liquid composition on a substrate. A transparent oleophobic and hydrophobic antimicrobial coating and articles having the coating applied thereon.

### TECHNICAL FIELD

The present invention relates to a composition and method of coating a substrate, more particularly to a composition and method for providing a clear and/or transparent omniphobic and hydrophobic antimicrobial coating for high touch surfaces that is durable and preferably smudge, streak, and/or fingerprint resistant.

### BACKGROUND

High touch surfaces, such as glass and/or plastic touch screens in phones, glass doors in restaurants and businesses, etc., are susceptible to showing fingerprints, dirt, smudges, and streaks (i.e., aesthetically unpleasing marks) thereon. Moreover and unless properly and frequently cleaned, these high touch surfaces tend to have high amounts of microbes deposited thereon from being frequently touched. In response to the above-mentioned problems, formulations and coatings have been used on these high touch surfaces in an attempt to reduce the frequency of cleaning these surfaces. Most prevalent chemistries for these conventional formulations and coating use fluorinated solvents that do not mix well with other chemistries, making it extremely difficult to add antimicrobial chemistries without impacting the aesthetic and tactile properties of these high touch surfaces. Moreover, these conventional coatings tend to have poor durability requiring frequent re-application to the high touch surfaces.

### SUMMARY

The present invention seeks to provide a durable omniphobic and hydrophobic transparent coating composition with both oil and water repellency that overcomes the above-mentioned problems while additionally exhibiting durable antimicrobial properties.

In particular, the present invention relates to liquid compositions and coatings (formed post-cure of the liquid compositions) that exhibit hydrophobic properties, omniphobic properties, and antimicrobial properties in which the coatings formed form the liquid compositions exhibit aesthetically pleasing transparency and tactile smoothness, long lasting durability (e.g., UV resistance), and desired antimicrobial properties during the life of the coating thereby overcoming numerous problems observed with conventional coatings. The coatings disclosed herein may also be advantageously streak resistant, smudge resistant, and/or fingerprint resistant thereby reducing the need to frequently clean high touch surfaces.

In an aspect of the invention, the liquid compositions disclosed herein include a fluorinated polymer, the liquid coupling agent, an acrylic polymer, an organic solvent, and an antimicrobial agent.

In an aspect of the invention, the liquid compositions disclosed herein include a fluorinated polymer, a silane coupling agent, an acrylic polymer, an organic solvent, quaternary ammonium silane, and an inorganic acid that includes, for example, hydrochloric acid (HCl).

In an aspect of the invention, the liquid compositions disclosed herein include a fluorinated polymer; a silane coupling agent; an acrylic homopolymer; an organic solvent; a quaternary ammonium silane; and an inorganic acid that includes, for example, hydrochloric acid (HCl).

In an aspect of the invention, a method of using the liquid composition is provided. The method comprises applying the liquid composition to a substrate and subsequently drying/curing the composition thereon thereby forming a coating that imparts a transparent and/or durable omniphobic antimicrobial property to the substrate.

Also disclosed herein are liquid compositions configured to form a transparent oleophobic and hydrophobic antimicrobial coating after application and post-cure of the liquid composition on a substrate. The liquid compositions comprise (a) a fluorinated polymer present at an effective amount to provide oleophobicity and/or hydrophobicity post-cure of the liquid composition on the substrate; (b) an acrylic polymer present at an effective amount to provide abrasion resistance and/or ultraviolet stability post-cure of the liquid composition on the substrate; (c) a coupling agent present at an effective amount to disperse (homogeneously disperse) the fluorinated polymer and acrylic polymer in the liquid composition; (d) an antimicrobial agent dispersed (homogeneously dispersed) in the liquid composition present at an effective amount to reduce and/or prevent microbial growth post-cure of the liquid composition on the substrate; and (e) an organic solvent at an effective amount to facilitate flowability of the liquid composition and/or to facilitate uniform formation of the transparent oleophobic and hydrophobic antimicrobial coating on the substrate post-cure of the liquid composition.

In certain aspects, the liquid compositions further comprise an inorganic acid present at an effective amount to facilitate curing of the liquid composition after application of the liquid composition on the substrate. In certain aspects the inorganic acid includes at least one of hydrochloric acid, nitric acid, phosphoric acid, or sulfuric acid. In certain aspects, the inorganic acid is preferably hydrochloric acid.

In certain aspects, the fluorinated polymer is selected from the group consisting of a fluorinated silane polymer, a perfluoro polyether siloxane polymer, and a combination thereof.

In certain aspects, the coupling agent is selected from the group consisting of a silane coupling agent with amine, alcohol, and/or ethoxy functionality.

In certain aspects, the organic solvent is selected from the group consisting of an alcohol, acetone, acetate, ketone, and a combination thereof.

In certain aspects, the antimicrobial agent is quaternary ammonium silane.

In certain aspects, the fluorinated polymer is present in the composition in an amount of 0.3 wt % to 1.5 wt % of the overall weight of the liquid composition.

In certain aspects, the coupling agent is present in the composition in an amount of 5.0 wt % to 30.0 wt % of the overall weight of the liquid composition.

In certain aspects, the acrylic polymer is present in the composition in an amount of 5.0 wt % to 25.0 wt % of the overall weight of the liquid composition.

In certain aspects, the organic solvent is present in the composition in an amount of 29.0 wt % to 85.0 wt % of the overall weight of the liquid composition.

In certain aspects, the antimicrobial agent is present in the composition in an amount of 0.5 wt % to 1.5 wt % of the overall weight of the liquid composition. In certain aspects, the antimicrobial agent is quaternary ammonium silane present at a concentration ranging from 0.5 wt % to 1.5 wt % of the overall weight of the liquid composition and more preferably from 0.5 to 1.4 wt % of the overall weight of the liquid composition.

In certain aspects, the acrylic polymer is an acrylic homopolymer.

In certain aspects, the coupling agent and acrylic polymer are present in the liquid composition at a ratio ranging from 1:5 to 6:1 relative to one another, ranging from 1:3 to 3:1 relative to one another, ranging from 2:1 to 1:2 relative to one another. In certain preferred aspects, the coupling agent and acrylic polymer are present in the liquid composition at a ratio of 2:1 relative to one another.

In certain aspects, the coupling agent and fluorinated polymer are present in the liquid composition at a ratio ranging from 3.33:1 to 100:1 relative to one another, 8:1 to 80:1 relative to one another, 15:1 to 50:1 relative to one another. In certain preferred aspects, the coupling agent and fluorinated polymer are present in the liquid composition at a ratio of 26:1 relative to one another.

In certain aspects, the antimicrobial agent is present in the liquid composition at a ratio ranging from 1:133 to 1:6.8 relative to a total combination of the fluorinated polymer, the coupling agent and the acrylic polymer.

Also disclosed herein are transparent oleophobic and hydrophobic antimicrobial coatings comprising the fluorinated polymer; the silane coupling agent; the acrylic polymer; and the quaternary ammonium silane at an effective amount to reduce and/or prevent microbial growth on a substrate. In certain aspects the transparent oleophobic and hydrophobic antimicrobial coating has a thickness of 0.1 μm to 1.5 μm, more preferably a thickness of 0.1 μm to 1.25 μm, and even more preferably a thickness of 0.3 μm to 1.0 μm. In certain aspects, the transparent oleophobic and hydrophobic antimicrobial coating has a thickness of less than 1.0 μm. In certain aspects, the transparent oleophobic and hydrophobic antimicrobial coating has a contact angle θ of greater than 100° and more preferably a contact angle θ of greater than 105°. Moreover, in certain aspects, the transparent oleophobic and hydrophobic antimicrobial coating exhibits a greater than 2 log reduction for Gram positive (+) and Gram negative (−) bacteria over the lifespan of the coating. In yet further aspects, the transparent oleophobic and hydrophobic antimicrobial coating exhibits a haze value of less than or equal to 10%.

In certain aspects, the fluorinated polymer of the coating is selected from the group consisting of a fluorinated silane polymer, a perfluoro polyether siloxane polymer, and a combination thereof.

In certain aspects, the fluorinated polymer of the coating is present in the transparent oleophobic and hydrophobic coating at a concentration ranging from 0.5 wt % to 20 wt % of the overall concentration of the transparent oleophobic and hydrophobic coating and more preferably from 0.7 wt % to 17 wt % of the overall concentration of the transparent oleophobic and hydrophobic coating.

In certain aspects, the silane coupling agent of the coating is present in the transparent oleophobic and hydrophobic coating at a concentration ranging from 20 wt % to 95 wt % of the overall concentration of the transparent oleophobic and hydrophobic coating and more preferably from 25 wt % to 91 wt % of the overall concentration of the transparent oleophobic and hydrophobic coating.

In certain aspects, the acrylic polymer is present in the transparent oleophobic and hydrophobic coating at a concentration ranging from 4 wt % to 65 wt % of the overall concentration of the transparent oleophobic and hydrophobic coating and more preferably from 5 wt % to 63 wt % of the overall concentration of the transparent oleophobic and hydrophobic coating.

In certain aspects, the quaternary ammonium silane of the coating is present in the transparent oleophobic and hydrophobic coating at a concentration ranging from 0.5 wt % to 13 wt % of the overall concentration of the transparent oleophobic and hydrophobic coating (post-cure on the substrate), more preferably from 1 wt % to 10 wt % of the overall concentration of the transparent oleophobic and hydrophobic coating (post-cure on the substrate), and most preferably 2 wt % to 8 wt %. It is further envisioned that any endpoint falling

In certain aspects, the acrylic polymer of the coating is an acrylic homopolymer.

In certain aspects, the coupling agent and acrylic polymer are present in the transparent oleophobic and hydrophobic coating at a ratio ranging from 1:5 to 6:1 relative to one another.

In certain aspects, the coupling agent and fluorinated polymer are present in the transparent oleophobic and hydrophobic coating at a ratio ranging from 3.33:1 to 100:1 relative to one another.

In certain aspects, the antimicrobial agent is present in the transparent oleophobic and hydrophobic coating at a ratio ranging from 1:133 to 1:6.8 relative to a total combination of the fluorinated polymer, the coupling agent and the acrylic polymer.

Also disclosed herein is a method comprising (a) applying the liquid compositions disclosed herein to a substrate, and (b) after step (a), curing the liquid composition on the substrate thereby forming a transparent oleophobic and hydrophobic antimicrobial coating on the substrate. In certain aspects the transparent oleophobic and hydrophobic antimicrobial coating has a thickness of 0.1 μm to 1.5 μm, more preferably a thickness of 0.1 μm to 1.25 μm, and even more preferably a thickness of 0.3 μm to 1.0 μm. In certain aspects, the transparent oleophobic and hydrophobic antimicrobial coating has a thickness of less than 1.0 μm. In certain aspects, the transparent oleophobic and hydrophobic antimicrobial coating has a contact angle θ of greater than 100° and more preferably a contact angle θ of greater than 105°. Moreover, in certain aspects, the transparent oleophobic and hydrophobic antimicrobial coating exhibits a greater than 2 log reduction for Gram positive (+) and Gram negative (−) bacteria over the lifespan of the coating. In yet further aspects, the transparent oleophobic and hydrophobic antimicrobial coating exhibits a haze value of less than or equal to 10%.

In certain aspects, the liquid composition is applied by at least one of spray coating, dip coating, roll coating, curtain coating, brush coating, or slot-die coating.

In certain aspects, during step (a), the liquid composition is evenly and/or homogeneously applied to the substrate.

In certain aspects, the transparent oleophobic and hydrophobic antimicrobial coating is uniformly formed on the substrate.

In certain aspects, the transparent oleophobic and hydrophobic antimicrobial coating of step (b) comprises at least two of the fluorinated polymer, acrylic polymer, coupling agent, and antimicrobial agent homogeneously dispersed therein.

In certain aspects, the transparent oleophobic and hydrophobic antimicrobial coating of step (b) comprises at least three of the fluorinated polymer, acrylic polymer, coupling agent, and antimicrobial agent homogeneously dispersed therein.

In certain aspects, the transparent oleophobic and hydrophobic antimicrobial coating of step (b) comprises each of the fluorinated polymer, acrylic polymer, coupling agent, and antimicrobial agent homogeneously dispersed therein.

In certain aspects, the transparent oleophobic and hydrophobic antimicrobial coating of step (b) has a thickness of ranging from 0.1 μm to 1.5 μm, more preferably a thickness of 0.1 μm to 1.25 μm, and even more preferably a thickness of 0.3 μm to 1.0 μm. In certain aspects, the transparent oleophobic and hydrophobic antimicrobial coating has a thickness of less than 1.0 μm. In certain aspects, coating thickness aids with overall coating durability, including, scratch resistance, UV resistance, or any combination thereof.

In certain aspects, the transparent oleophobic and hydrophobic antimicrobial coating of step (b) is fingerprint resistant and/or smudge resistant.

In certain aspects, the substrate is a planar substrate.

In certain aspects, the substrate is a rigid, planar substrate.

In certain aspects, the substrate comprises a transparent glass or transparent plastic (e.g., polyethylene or polypropylene substrates).

In certain aspects, the substrate is metal, ceramic, or porcelain.

In certain aspects, the substrate is transparent and the transparent oleophobic and hydrophobic antimicrobial coating of step (b), and there are no visual differences between the transparencies of the substrate and the transparent oleophobic and hydrophobic antimicrobial coating of step (b) and the outermost surface of the coating is preferably smooth.

In certain aspects, the transparent oleophobic and hydrophobic antimicrobial coating of step (b) is permanently formed on the substrate.

Also disclosed herein are articles comprising a substrate with liquid compositions disclosed herein applied to the substrate.

In certain aspects, the substrate is a transparent glass or transparent plastic (e.g., polyethylene or polypropylene substrates).

In certain aspects, the fluorinated polymer is present in the composition in an amount of 0.3 wt % to 1.5 wt % of the overall weight of the liquid composition.

In certain aspects, the coupling agent is present in the composition in an amount of 5.0 wt % to 30.0 wt % of the overall weight of the liquid composition.

In certain aspects, the acrylic polymer is present in the composition in an amount of 5.0 wt % to 25.0 wt % of the overall weight of the liquid composition.

In certain aspects, the organic solvent is present in the composition in an amount of 29.0 wt % to 85.0 wt % of the overall weight of the liquid composition.

In certain aspects, the antimicrobial agent is present in the composition in an amount of 0.5 wt % to 1.5 wt % of the overall weight of the liquid composition.

In certain aspects, the coupling agent and acrylic polymer are present in the liquid composition at a ratio ranging from 1:5 to 6:1 relative to one another, ranging from 1:3 to 3:1 relative to one another, ranging from 2:1 to 1:2 relative to one another. In certain preferred aspects, the coupling agent and acrylic polymer are present in the liquid composition at a ratio of 2:1 relative to one another.

In certain aspects, the coupling agent and fluorinated polymer are present in the liquid composition at a ratio ranging from 3.33:1 to 100:1 relative to one another, 8:1 to 80:1 relative to one another, 15:1 to 50:1 relative to one another. In certain preferred aspects, the coupling agent and fluorinated polymer are present in the liquid composition at a ratio of 26:1 relative to one another.

In certain aspects, the antimicrobial agent is present in the liquid composition at a ratio ranging from 1:133 to 1:6.8 relative to a total combination of the fluorinated polymer, the coupling agent and the acrylic polymer.

Also disclosed herein are articles comprising a substrate with the transparent oleophobic and a hydrophobic coating as disclosed herein applied to the substrate. In certain aspects the transparent oleophobic and hydrophobic antimicrobial coating has a thickness of 0.1 μm to 1.5 μm, more preferably a thickness of 0.1 μm to 1.25 μm, and even more preferably a thickness of 0.3 μm to 1.0 μm. In certain aspects, the transparent oleophobic and hydrophobic antimicrobial coating has a thickness of less than 1.0 μm. In certain aspects, the transparent oleophobic and hydrophobic antimicrobial coating has a contact angle θ of greater than 100° and more preferably a contact angle θ of greater than 105°. Moreover, in certain aspects, the transparent oleophobic and hydrophobic antimicrobial coating exhibits a greater than 2 log reduction for Gram positive (+) and Gram negative (−) bacteria over the lifespan of the coating. In yet further aspects, the transparent oleophobic and hydrophobic antimicrobial coating exhibits a haze value of less than or equal to 10%.

In certain aspects, the substrate is a transparent glass or transparent plastic (e.g., polyethylene or polypropylene substrates).

In certain aspects, the coupling agent and acrylic polymer are present in the coating at a ratio ranging from 1:5 to 6:1 relative to one another.

In certain aspects, the coupling agent and fluorinated polymer are present in the coating at a ratio ranging from 3.33:1 to 100:1 relative to one another.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

These and other features, aspects and advantages of the present invention are better understood when the following detailed description of the invention is read with reference to the accompanying drawings, in which:

FIG. 1A and FIG. 1B are photographs depicting substrates having comparative compositions applied to and cured on the substrates, which further display poor film formation that is aesthetically unpleasing, not evenly formed on the substrate, and susceptible to delamination from the substrate.

FIG. 1C is a photograph depicting an exemplary transparent oleophobic and hydrophobic antimicrobial coating formed on a substrate having the desired transparency, durability, hydrophobicity and oleophobicity, and antibacterial properties.

### DETAILED DESCRIPTION

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within the ranges as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. as well as 1, 2, 3, 4, and 5, individually. The same principle applies to ranges reciting only one numerical value as a minimum or a maximum. Furthermore, such an interpretation should apply regardless of the breadth of the range or the characteristics being described.

Disclosed herein are liquid compositions configured to form a transparent oleophobic and hydrophobic antimicrobial coating after application and post-cure of the liquid composition on a substrate. Also, disclosed herein are transparent oleophobic and hydrophobic antimicrobial coating(s) formed after application and post-cure of the liquid composition on the substrate. Also disclosed herein are methods and articles formed for having the liquid compositions and/or coatings thereon. As discussed further below, these liquid compositions includes a fluorinated polymer, a coupling agent, an acrylic polymer, an antimicrobial agent, and an organic solvent. In certain aspects, the liquid composition includes: a fluorinated polymer, a coupling agent, an acrylic homopolymer, an antimicrobial agent, and an organic solvent. The liquid composition may further include an acid such as HCl to be used as a catalyst for a hydrolysis reaction that can occur between the fluorinated polymer and the acrylic polymer.

Liquid Compositions that Form Transparent Oleophobic and Hydrophobic Antimicrobial Coating(s)

Disclosed herein are liquid compositions configured to form a transparent oleophobic and hydrophobic antimicrobial coating after application and post-cure of the liquid composition on a substrate. The liquid compositions include (a) a fluorinated polymer present at an effective amount to provide oleophobicity and/or hydrophobicity post-cure of the liquid composition on the substrate; (b) an acrylic polymer present at an effective amount to provide abrasion resistance and/or ultraviolet stability post-cure of the liquid composition on the substrate; (c) a coupling agent present at an effective amount to disperse (e.g., homogeneously disperse) the fluorinated polymer and acrylic polymer in the liquid composition; (d) an antimicrobial agent dispersed (e.g., homogeneously dispersed) in the liquid composition present at an effective amount to reduce and/or prevent microbial growth post-cure of the liquid composition on the substrate; and (e) an organic solvent at an effective amount to facilitate flowability of the liquid composition and/or to facilitate uniform formation of the transparent oleophobic and hydrophobic antimicrobial coating on the substrate post-cure of the liquid composition. The viscosity of the liquid formulation, at 25° C., is preferably less than 25 cPs. The viscosity of the formulation determines the thickness of the resulting coating. The liquid disclosed herein is preferably clear at ambient temperatures in which no components precipitate while stored at ambient temperatures for up to six months, one year, two years, or three years.

Fluorinated Polymer in the Liquid Composition

Examples of fluorinated polymers within the disclosed liquid compositions include, but are not limited to, fluorinated silane polymers, perfluoro polyether siloxane polymer, and a combination thereof. In one example, the fluorinated polymer is perfluoro polyether siloxane that includes: (C₂H₅O)₃Si(CH₂)₃N (H(C(O)—Rf—C(O)N(H)(CH₂)₃ Si(OC₂H₅)₃Rf represents the perfluoro component with CF₂O—(CF₂—CF₂—O)ₙ—(CF₂—O)ₘCF₂ (CAS No. 207574-77-4) (Sold under the trademark 3M™ Easy Clean Coating ECC-1000). The effective amounts of fluorinated polymer in the liquid composition advantageously provide water and oil repellency (desired hydrophobicity and oleophobicity) in the coating post-cure on the substrate, which advantageously imparts fingerprint and smudge resistance/resistant properties in the end resulting coating.

The liquid composition includes from 0.3 weight % to 1.5 weight % of the fluorinated polymer, based on the total weight to the liquid composition. Preferably, the liquid composition comprises from 0.5 weight % to 1 weight % of the fluorinated polymer, based on the total weight to the liquid composition. Most preferably, the liquid composition comprises from 0.5 weight % to 0.8 weight % of the fluorinated polymer, based on the total weight to the liquid composition. It is further envisioned that any endpoint falling within the above disclosed ranges may serve as additional ranges. If the concentration of the fluorinated polymer is lower than approximately 0.3 weight % in the liquid composition the resulting coating post-cure will not repel water and oil sufficiently. Conversely, if the concentration of the fluorinated polymer exceeds approximately 1.5 weight % in the liquid composition, the water and oil repellency is not improved.

In certain aspects, the fluorinated polymer is homogeneously dispersed in the liquid composition.

Acrylic Polymer in the Liquid Composition

The liquid composition further includes an acrylic polymer, preferably an acrylic homopolymer, that provides improved durability of the resulting coating post-cure (e.g., improved coating hardness, abrasion resistance, and UV stability/resistance). One example of a suitable acrylic polymer is polyacrylic acid, CAS No. 9003-01-4, (sold under the Trademark Carboset® GA-1594). The acrylic polymer hardens upon curing/drying thereby solidifying the coating, affixing the coating to the substrate, and further providing the desired coating durability. The concentration of acrylic polymer in the liquid composition is, as the acrylic, should be at a sufficient to harden and bond (e.g., permanently bond via physical interaction (van der Waals force and/or hydrogen bonding) the coating (post-cure) to the substrate. To achieve these desired properties, the liquid composition should include from 5.0 weight % to 25 weight % of the acrylic polymer, based on the total weight of the liquid composition. Preferably, the liquid composition may include from 7 weight % to 12 weight % of the acrylic polymer, based on the total weight of the liquid composition. Most preferably, the composition may comprise from 7.5 weight % to 10 weight % of the acrylic polymer, based on the total weight of the liquid composition. It is further envisioned that any endpoint falling within the above disclosed ranges may serve as additional ranges.

In certain aspects, the acrylic polymer is homogeneously dispersed in the liquid composition, which may be achieved with, for example, the above-mentioned acrylic polymer concentrations. It should be further appreciated that if the acrylic polymer exceeds 25 weight % based on the total weight of the liquid composition the end resulting coating (post-cure) becomes hazy, non-transparent and undersirable.

Coupling Agent in the Liquid Composition

To further aid in dispersing (e.g., homogeneously dispersing) the acrylic polymer and/or the fluorinated polymer(s) within the disclosed liquid composition as well as during coating formation (i.e., curing of the liquid composition), a coupling agent should be included. In certain aspects, the coupling agent is a silane coupling agent, preferably a silane coupling agent that has an amine, alcohol, and/or ethoxy functionality such as an ethoxylated silane.

It should be appreciated that post-application of the liquid composition and during curing, the coupling agent forms cross-links between the acrylic polymer and the fluorinated polymer (and potentially the substrate if the substrate is functionalized substrate capable of cross-linking/covalent bonding) thereby aiding in solidification and strengthening of the end resulting coating as well as homogeneously dispersing the chemical components throughout the coating post-cure. The liquid composition includes from 5.0 weight % to 30 weight % of the coupling agent, based on the total weight of the composition. Preferably, the composition includes from 12 weight % to 20 weight % of the coupling agent, based on the total weight of the composition. Most preferably, the composition includes from 14 weight % to 16 weight % of the coupling agent, based on the total weight of the composition. It is further envisioned that any endpoint falling within the above disclosed ranges may serve as additional ranges. If the coupling agent is present at a concentration less than the recommended range, the coating will be hazy and non-transparent.

In certain aspects and in view of the above-mentioned concentrations, the coupling agent and acrylic polymer are present in the liquid compositions at a ratio ranging from 1:5 to 6:1 relative to one another. It is further envisioned that any endpoint falling within the above disclosed ratio ranges may serve as additional endpoints for additional ratio ranges. Moreover, the coupling agent and fluorinated polymer are present in the liquid compositions at a ratio ranging from 3.33:1 to 100:1 relative to one another. It is further envisioned that any endpoint falling within the above disclosed ratio ranges may serve as additional endpoints for additional ratio ranges. When these components fall outside of these ratio ranges in combination with the disclosed concentration ranges, dispersibility of the chemical components in the liquid composition may be affected and/or the end resulting coating (post-cure) may be adversely affected (e.g., weaker coating/durability, weakened UV resistance, hazy appearance, more prone to delamination from the substrate).

Non-limiting examples of such a silane coupling agent is a primary amine terminated silane coupling agent such as 3-Aminopropyltriethoxysilane, CAS-919-30-2, 3-(2,3-epoxypropoxy)propyl]trimethoxysilane, CAS-2530-83-8 (sold under the Trademark DYNASYLAN® GLYMO), and a combination thereof.

Antimicrobial Agent in the Liquid Composition

To further impart the desired antimicrobial activity in the end resulting coating, a suitable antimicrobial agent is included within the disclosed liquid compositions at effective amounts to reduce and/or prevent microbial growth. The antimicrobial agent can be, for example, a quaternary ammonium silane dispersed (homogeneously dispersed) and/or dissolved in the liquid composition. Non-limiting examples of antimicrobial agents include: (3-(trimethoxysilyl)propyldimethyloctadecyl ammonium chloride) (sold under the trademark AEM® 5772), (3-(trimethoxysilyl)propylmethyldi(decyl)ammonium chloride) (sold under the trademark REQUAT® 1977), and combinations thereof.

The concentration of the antimicrobial agent should be sufficient to provide antimicrobial efficacy, while not exceeding the recommended limits from the EPA. Additionally, if the concentration of antimicrobial agent exceeds the enclosed recommended amounts, a hazy, non-transparent coating will result post-cure.

The liquid composition includes from 0.5 weight % to 1.39 weight % of the antimicrobial agent, based on the total weight of the liquid composition. Preferably, the liquid composition includes from 0.8 weight % to 1.25 weight % of the antimicrobial agent, based on the total weight of the liquid composition. Most preferably, the composition includes from 0.9 weight % to 1.10 weight % of the antimicrobial agent, based on the total weight of the liquid composition. It is further envisioned that any endpoint falling within the above disclosed ranges may serve as additional ranges.

In certain aspects the liquid composition comprises: a fluorinated polymer, a silane coupling agent, an acrylic polymer, an organic solvent, quaternary ammonium silane, and hydrochloric acid (HCl).

Organic Solvent in the Liquid Composition

The disclosed liquid compositions also include organic solvents at an effective amount to facilitate flowability of the liquid composition and/or to facilitate uniform formation of the transparent oleophobic and hydrophobic antimicrobial coating on the substrate post-cure of the liquid composition. These organic solvents can be polar or non-polar, and examples of the organic solvent includes, but is not limited to, alcohol, acetone, acetate, ketone, or a combination thereof. A non-limiting example of an alcohol is ethanol, isopropyl alcohol, benzyl alcohol, among others. A non-limiting example of a ketone Methyl Ethyl Ketone (MEK). The organic solvent is preferably a polar solvent.

The liquid composition includes from 29.0 weight % to 85.0 weight % of the organic solvent, based on the total weight to the liquid composition. Preferably, the liquid composition 45 weight % to 80 weight % of the organic solvent, based on the total weight of the liquid composition. Most preferably, the liquid composition includes from 60 weight % to 75 weight percent of the organic solvent, based on the total weight of the composition. It is further envisioned that any endpoint falling within the above disclosed ranges may serve as additional ranges.

In additional aspects, the liquid compositions further include an inorganic acid present at an effective amount to facilitate curing of the liquid composition after application of the liquid composition on the substrate. The inorganic acid includes at least one of hydrochloric acid, nitric acid, phosphoric acid, or sulfuric acid. In certain aspects, the inorganic acid is preferably hydrochloric acid. The liquid composition includes from 0.5 weight % to 5.0 weight % of the inorganic acid, based on the total weight of the liquid composition. Preferably, the liquid composition includes from 0.9 weight % to 4.5 weight % of the inorganic acid, based on the total weight of the liquid composition. Most preferably, the liquid composition includes from 0.9 weight % to 1.10 weight % of the inorganic acid, based on the total weight of the liquid composition. It is further envisioned that any endpoint falling within the above disclosed ranges may serve as additional ranges. The pH of the liquid formulation should be between 5 and 7 to facilitate polymerization.

Transparent Oleophobic and Hydrophobic Antimicrobial Coatings

As alluded to above, the above-mentioned liquid compositions are applied to various substrates and subsequently dry/cure on the substrates thereby forming the transparent oleophobic and hydrophobic antimicrobial coatings (e.g., permanent coating bound to the substrate via physical interaction (van der Waals force and/or hydrogen bonding) or covalently bonded to a functionalized substrate) having the desired durable, transparent/non-hazy, and antimicrobial characteristics discussed herein. It should be appreciated that during drying/curing that the above-mentioned liquid components (e.g., organic solvent, inorganic acid, etc.) either dry and/or evaporate such that substantially no liquid components remain in the transparent oleophobic and hydrophobic antimicrobial coatings.

In particular, the resulting transparent oleophobic and hydrophobic antimicrobial coatings include the fluorinated polymer; the silane coupling agent; the acrylic polymer; and the quaternary ammonium silane at an effective amount to reduce and/or prevent microbial growth on the substrate

In certain aspects the transparent oleophobic and hydrophobic antimicrobial coating has a thickness of 0.1 μm to 1.5 μm, more preferably a thickness of 0.1 μm to 1.25 μm, and even more preferably a thickness of 0.3 μm to 1.0 μm post application to and post-cure on the substrate. The overall thickness aids in the durability of the coating (e.g., UV resistance and prolonged antimicrobial activity). In certain aspects, the transparent oleophobic and hydrophobic antimicrobial coating has a thickness of less than 1.0 μm.

Moreover, the transparent oleophobic and hydrophobic antimicrobial coating (post-cure on the substrate) has a contact angle θ of greater than 100° and more preferably a contact angle θ of greater than 105° thereby exhibiting the desired hydrophobicity coupled with oleophobicity to impart water resistance and oil/fingerprint/smudge resistance thereby maintaining a prolonged visually “clean”/aesthetically clean appearance that reduces the overall need to frequently clean a surface/coated substrate.

The transparent oleophobic and hydrophobic antimicrobial coating (post-cure on the substrate) further advantageously exhibits a greater than 2 log reduction for Gram positive (+) and Gram negative (−) bacteria over the lifespan of the coating, which again aids in maintaining a prolonged visually “clean”/aesthetically clean appearance that reduces the overall need to frequently clean a surface/coated substrate.

The lifespan of the coating is greater than 500 hours, as confirmed by the QUV test. In certain aspects, the lifespan of the coating ranges from 500 hours to 3000 hours. The lifespan of the coating may be greater than or equal to 1000 hours. The lifespan of the coating may be greater than or equal to 1500 hours. The lifespan of the coating may be greater than or equal to 2-4 weeks. The lifespan of the coating may be greater than or equal to 3-6 weeks. The lifespan of the coating may be greater than or equal to 7-9 weeks. It is further envisioned that any endpoint falling within the above disclosed ranges may serve as additional ranges.

The fluorinated polymer of the coating is present in the transparent oleophobic and hydrophobic coating (post-cure on the substrate) at a concentration ranging from 0.5 wt % to 20 wt % of the overall concentration of the transparent oleophobic and hydrophobic coating and more preferably from 0.7 wt % to 17 wt % of the overall concentration of the transparent oleophobic and hydrophobic coating (post-cure on the substrate). It is further envisioned that any endpoint falling within the above disclosed ranges may serve as additional ranges.

The silane coupling agent of the coating (post-cure on the substrate) is present in the transparent oleophobic and hydrophobic coating at a concentration ranging from 20 wt % to 95 wt % of the overall concentration of the transparent oleophobic and hydrophobic coating and more preferably from 25 wt % to 91 wt % of the overall concentration of the transparent oleophobic and hydrophobic coating (post-cure on the substrate). It is further envisioned that any endpoint falling within the above disclosed ranges may serve as additional ranges.

The acrylic polymer is present in the transparent oleophobic and hydrophobic coating (post-cure on the substrate) at a concentration ranging from 4 wt % to 65 wt % of the overall concentration of the transparent oleophobic and hydrophobic coating (post-cure on the substrate) and more preferably from 5 wt % to 63 wt % of the overall concentration of the transparent oleophobic and hydrophobic coating (post-cure on the substrate). It is further envisioned that any endpoint falling within the above disclosed ranges may serve as additional ranges.

The quaternary ammonium silane of the coating is present in the transparent oleophobic and hydrophobic coating at a concentration ranging (post-cure on the substrate) from 0.75 wt % to 13 wt % of the overall concentration of the transparent oleophobic and hydrophobic coating (post-cure on the substrate), more preferably from 1 wt % to 10 wt % of the overall concentration of the transparent oleophobic and hydrophobic coating (post-cure on the substrate), and most preferably 2 wt % to 8 wt %. It is further envisioned that any endpoint falling within the above disclosed ranges may serve as additional ranges.

The coupling agent and acrylic polymer are present in the transparent oleophobic and hydrophobic coating at a ratio ranging from 1:5 to 6:1 relative to one another. The coupling agent and fluorinated polymer are present in the transparent oleophobic and hydrophobic coating at a ratio ranging from 3.33:1 to 100:1 relative to one another.

In certain aspects, the antimicrobial agent is present in the transparent oleophobic and hydrophobic coating at a ratio ranging from 1:132 to 1:6.69 relative to a total combination of the fluorinated polymer, the coupling agent and the acrylic polymer.

Methods of Applying the Liquid Compositions to the Substrate

Also disclosed herein is a method comprising (a) applying the liquid composition(s) disclosed above to a desired substrate, and after (a), curing the liquid composition on the substrate thereby forming the desired transparent oleophobic and hydrophobic antimicrobial coating on the substrate. Curing can be done with or without the addition of heat. If heat is used, the temperature should not exceed 150° C. During step (a), the liquid composition may be applied by at least one of spray coating, dip coating, roll coating, curtain coating, brush coating, or slot-die coating at desired, controlled conditions that result in an even, uniform, and/or homogeneous application to a desired surface of the substrate, which subsequently results in a smooth, even, uniform, and/or homogeneous applied transparent oleophobic and hydrophobic antimicrobial coating on the substrate (post-cure). With regard to the transparent oleophobic and hydrophobic antimicrobial coating (post-cure on the substrate), there are no visual differences between the transparencies of the substrate and the transparent oleophobic and hydrophobic antimicrobial coating.

In certain aspects, the substrate is a planar substrate. The substrate is a rigid, planar substrate. In certain aspects, the substrate is a transparent glass or transparent plastic (e.g., polyethylene or polypropylene substrates).

As alluded to above, the transparent oleophobic and hydrophobic antimicrobial coating is preferably permanently formed/bonded to the substrate (post-cure).

Articles

Also disclosed herein are the end-use articles having the transparent oleophobic and hydrophobic antimicrobial coating cured on the substrate (bonded/permanently bonded) resulting the desired durable, transparent/non-hazy, and antimicrobial characteristics discussed herein. The substrate is a preferably planar substrate and more preferably a rigid, planar substrate having the transparent oleophobic and hydrophobic antimicrobial coating applied on one or more of its outermost surface(s). In certain aspects, the substrate is a transparent glass or transparent plastic (e.g., polyethylene or polypropylene substrates). In certain aspects, the substrate is metal, ceramic, or porcelain. In certain aspects, the end-use article is a handheld device such as a phone, point-of-sale kiosk or device, or a tablet. Other end-use articles include: outdoor electronics such as ATMs and gas pump stations, countertops, doorknobs, handles, buttons, and hand-rails.

The transparent oleophobic and hydrophobic antimicrobial coating in the article has a thickness of 0.1 μm to 1.5 μm, more preferably a thickness of 0.1 μm to 1.25 μm, and even more preferably a thickness of 0.3 μm to 1.0 μm post application to and post-cure on the substrate. The overall thickness aids in the durability of the coating in the article (e.g., UV resistance and prolonged antimicrobial activity). In certain aspects, the transparent oleophobic and hydrophobic antimicrobial coating has a thickness of less than 1.0 μm.

Moreover, the transparent oleophobic and hydrophobic antimicrobial coating in the article (post-cure on the substrate) has a contact angle θ of greater than 100° and more preferably a contact angle θ of greater than 105° thereby exhibiting the desired hydrophobicity coupled with oleophobicity to impart water resistance and oil/fingerprint/smudge resistance thereby maintaining a prolonged visually “clean”/aesthetically clean appearance that reduces the overall need to frequently clean a surface.

The transparent oleophobic and hydrophobic antimicrobial coating in the article (post-cure on the substrate) further advantageously exhibits a greater than 2 log reduction for Gram positive (+) and Gram negative (−) bacteria over the lifespan of the coating, which again aids in maintaining a prolonged visually “clean”/aesthetically clean appearance that reduces the overall need to frequently clean a surface.

The fluorinated polymer of the coating is present in the transparent oleophobic and hydrophobic coating of the article (post-cure on the substrate) at a concentration ranging from 0.5 wt % to 20 wt % of the overall concentration of the transparent oleophobic and hydrophobic coating of the article and more preferably from 0.7 wt % to 17 wt % of the overall concentration of the transparent oleophobic and hydrophobic coating (post-cure on the substrate).

The silane coupling agent of the coating in the article (post-cure on the substrate) is present in the transparent oleophobic and hydrophobic coating at a concentration ranging from 20 wt % to 95 wt % of the overall concentration of the transparent oleophobic and hydrophobic coating and more preferably from 25 wt % to 91 wt % of the overall concentration of the transparent oleophobic and hydrophobic coating (post-cure on the substrate).

The acrylic polymer is present in the transparent oleophobic and hydrophobic coating of the article (post-cure on the substrate) at a concentration ranging from 4 wt % to 65 wt % of the overall concentration of the transparent oleophobic and hydrophobic coating (post-cure on the substrate) and more preferably from 5 wt % to 63 wt % of the overall concentration of the transparent oleophobic and hydrophobic coating (post-cure on the substrate).

The quaternary ammonium silane of the coating is present in the transparent oleophobic and hydrophobic coating in the article at a concentration ranging (post-cure on the substrate) from 0.5 wt % to 13 wt % of the overall concentration of the transparent oleophobic and hydrophobic coating (post-cure on the substrate), more preferably from 1 wt % to 10 wt % of the overall concentration of the transparent oleophobic and hydrophobic coating (post-cure on the substrate), and most preferably 2 wt % to 8 wt %. It is further envisioned that any endpoint falling In certain aspects, the coupling agent and acrylic polymer are present in the coating at a ratio ranging from 1:5 to 6:1 relative to one another.

In certain aspects, the coupling agent and fluorinated polymer are present in the coating at a ratio ranging from 3.33:1 to 100:1 relative to one another.

Examples of end use applications include, but are not limited to, thin coatings on surfaces or substrates that have a high surface energy (glass, polycarbonate, etc.) such as touch screens.

There is a synergistic and unexpected effect achieved with the combination of the fluorinated polymer, coupling agent, and acrylic polymer.

### WORKING EXAMPLES

### Example 1

To evidence proof of concept, an exemplary liquid composition that forms the transparent oleophobic and hydrophobic antimicrobial coating on a substrate is provided in Table 1.

TABLE 1

| Component | Commercial Name | Weight Percentage |
|---|---|---|
| Organic Solvent | Ethanol | 72.54 |
| Fluorinated polymer | 3M ™ Easy Clean Coating | 0.6 |
| | ECC-1000 | |
| Acrylic Polymer | Carboset ® GA-1594 | 7.95 |
| Coupling Agent | DYNASYLAN ® GLYMO | 15.9 |
| Antimicrobial Agent | AEM ® 5772 | 1.03 |
| Catalyst | Hydrochloric acid (37%) | 2.38 |

In a method of making the composition, ethanol, acrylic polymer, coupling agent, antimicrobial agent, and fluorinated polymer were mixed for 1 hour at low speed (300-600 RPM), then HCl was slowly added and mixed for 1.5 hours. The solution was allowed to equilibrate at room temperature overnight until mixture was clear. The solution was applied to an untreated glass substrate and cured with heat at 80° C. for 30 minutes for complete cure resulting a glass substrate having transparent oleophobic and hydrophobic antimicrobial coating formed thereon.

As shown in Table 2, tests were conducted to analyze antimicrobial efficacy of certain samples when quaternary ammonium silane (AEM 5772) was present in the composition (Sample #1, 2, 3) as compared to samples when AEM 5772 was not included (Sample #4, 5, 6). The results, shown in Table 2, show that when AEM 5772 is present in the composition, there was a high amount of antibacterial efficacy. When AEM 5772 was included in Sample #1, 2, and 3, the log reductions were 4.7, 3.9, and 4.7 respectively. However, no antimicrobial efficacy was demonstrated when AEM 5772 was not present in the composition. The tests were conducted pursuant to ISO Protocol 22196. To test for antimicrobial efficacy, the composition was tested on E. coli (Ec), a gram-negative bacteria, and Staphylococcus aureus (Sa), a gram-positive bacteria. C_PP PGCs are the lab controls for the test.

In addition to antibacterial efficacy, antifungal efficacy was determined using the AATCC 30411 test (TM30) and the ASTM G21 (G21) test were performed. For the TM30 test, a score of 0 will be given if the sample exhibits strong antifungal activity, a score of 1 is given when the sample is not supportive of fungal growth, and a score of 2 given when the sample is susceptible to fungal growth. For the G21 test, a score of 0 is given when the sample has no fungal growth, a score of 1 is given when there are traces of growth (<10%), a score of 2 is given when there is light fungal growth (10-30%), a score of 3 is given when there is medium fungal growth (30-60%), and a score of 4 is given when there is heavy fungal growth (60-100%). As shown in Table 2, the Exemplary sample are not supportive of fungal growth (TM30) and show less than 10% traces of fungal growth (G21).

TABLE 2

| | | Ec | | Sa | | TM30 | | G21 | |
|---|---|---|---|---|---|---|---|---|---|
| | | Viable | Log | Viable | Log | Rep | Rep | Rep | Rep |
| Sample | | Organisms | Reduction | Organisms | Reduction | 1 | 2 | 1 | 2 |
| Inoculum [TEMPO(Ec- | | 220000 | | 190000 | | | | | |
| 1:500 JNB, Sa-1:250 JNB)] | | | | | | | | | |
| Exemplary 1 | 1% AEM | <100 | 4.7 | <100 | 4.6 | 1 | 1 | 1 | 1 |
| | 5772 | | | | | | | | |
| | (Rep 1) | | | | | | | | |
| Exemplary 2 | 1% AEM | 600 | 3.9 | <100 | 4.6 | | | | |
| | 5772 | | | | | | | | |
| | (Rep 2) | | | | | | | | |
| Exemplary 3 | 1% AEM | <100 | 4.7 | <100 | 4.6 | | | | |
| | 5772 | | | | | | | | |
| | (Rep 3) | | | | | | | | |
| Comparative 4 | 0% AEM | >4900000 | 0 | 1700000 | 0.5 | 2 | 1 | 2 | 1 |
| | 5772 | | | | | | | | |
| | (Rep 1) | | | | | | | | |
| Comparative 5 | 0% AEM | >4900000 | 0 | 93000 | 1.7 | | | | |
| | 5772 | | | | | | | | |
| | (Rep 2) | | | | | | | | |
| Comparative 6 | 0% AEM | >4900000 | 0 | 4900000 | 0.4 | | | | |
| | 5772 | | | | | | | | |
| | (Rep 3) | | | | | | | | |
| Comparative 01 | C PP | >4900000 | | 4900000 | | | | | |
| | PGCs | | | | | | | | |
| Comparative 02 | C PP | >4900000 | | 3000000 | | | | | |
| | PGCs | | | | | | | | |
| Comparative 03 | C PP | >4900000 | | 4160745 | | | | | |
| | PGCs | | | | | | | | |

Additional Exemplary and Comparative Formulations

To further demonstrate proof of concept, additional Comparative and Exemplary formulations were prepared according to Table 3 (i.e., Comparative Formulations 1, 3, 4, 6, 7, and 11 and Exemplary Formulations 2, 5, 8, 9, and 10) and were applied to glass substrates identically as those discussed above in Tables 1 and 2. Properties measured include: Haze, contact angle, and antibacterial efficacy, as shown in Table 4. Haze was measured using an X-Rite Spectrophotometer, a formulation was considered to pass with a measurement of less than or equal to 10%. Contact angle was measured using the Sessile drop test on a Kruss DSA 30 drop shape analyzer. The contact angle of water is measured to determine the hydrophobicity of the coating, and the contact of hexadecane is measured to determine the oleophobicity of the coating. The contact angles, 0, are measure at T₀ and at T₅₀₀ (accelerated weathering tester 340 nm, 0.89 irradiance at 60° C. for 500 hours). A contact angle for water, ewater, is considered to pass if greater than or equal to 105°. A contact angle for hexadecane, Onexadecane, is considered to pass if greater than or equal to 60°. Antibacterial efficacy is measured using ISO 22196. A coating is considered to pass if it exhibits a 2 log reduction in bacterial growth or greater.

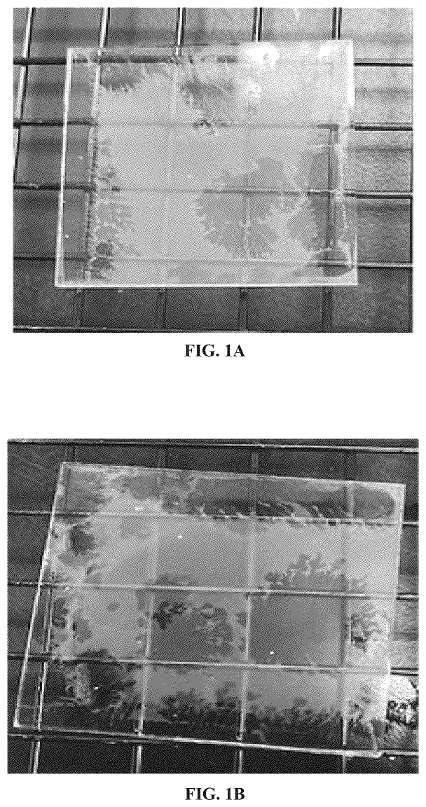

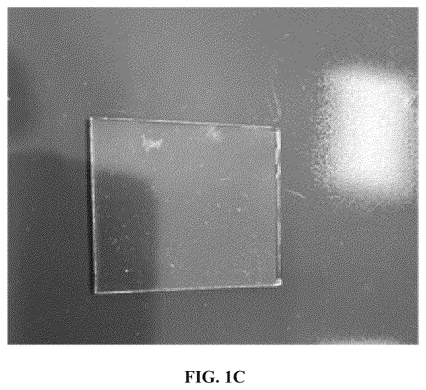

Based on the data shown in Tables 3 and 4, when the formulation lacks the Quat Silane (AEM 5772), as is the case with Comparative Formulation 11, the coating does not show any antimicrobial efficacy. When the formulation has too little or no silane coupler (Dynasylan Glymo), as is the case with Comparative formulations 6 and 7, the coating has poor film formation. This can be seen in FIG. 1A which illustrates a coating formed by Comparative Formulation 6 and FIG. 1B which illustrates a coating formed by Comparative Example 7. When the formulation has no acrylic (Carboset GA 1594) or silane coupler (Dynasylan Glymo), the resulting coating is hazy, as is the case with Comparative Formulation 1. Additionally, when the formulation has too much acrylic (Carboset GA), as is the case with Comparative Formulation 4, the coating has poor film formation. If the formulation has too much acid, as is the case with Comparative Formulation 3, the coating has poor film formation. The Exemplary Formulations 2 and 5 each have the desired coating properties. An exemplary coating formed from Exemplary Formulation 2 is shown in FIG. 2.

TABLE 3

| | | Carboset | Dynasylan | Easy-Clean | | |
|---|---|---|---|---|---|---|
| | | GA 1594 | Glymo | Coating | AEM 5772 | Hydrochloric |
| Formulation | Ethanol | (40%) | (100%) | 1000 (100%) | (72%) | acid (37%) |
| Comparative 1 | 97.61 | 0.00 | 0.00 | 0.70 | 1.00 | 0.70 |
| Exemplary 2 | 61.06 | 14.42 | 19.23 | 1.44 | 0.96 | 2.88 |
| Comparative 3 | 52.05 | 24.59 | 16.39 | 1.23 | 0.82 | 4.92 |
| Comparative 4 | 53.36 | 25.21 | 16.81 | 1.26 | 0.84 | 2.52 |
| Exemplary 5 | 82.14 | 10.27 | 5.13 | 0.72 | 1.03 | 0.72 |
| Comparative 6 | 82.57 | 13.76 | 0.00 | 1.38 | 0.92 | 1.38 |
| Comparative 7 | 82.19 | 13.70 | 0.46 | 1.37 | 0.91 | 1.37 |
| Exemplary 8 | 69.55 | 11.59 | 15.46 | 0.31 | 0.77 | 2.32 |
| Exemplary 9 | 74.49 | 4.66 | 18.62 | 0.65 | 0.93 | 0.65 |
| Exemplary 10 | 53.36 | 12.61 | 29.41 | 1.26 | 0.84 | 2.52 |
| Comparative 11 | 96.36 | 0.00 | 0.00 | 0.69 | 0.00 | 2.95 |

TABLE 4

| | | T₀ | T₀ | T₅₀₀ | T₅₀₀ | Antibacterial |
|---|---|---|---|---|---|---|
| Formulation | Haze | ⊖_{H2O} | ⊖_{hexadecane} | ⊖_{H2O} | ⊖_{hexadecane} | Efficacy |
| Comparative 1 | x | ∘ | ∘ | x | x | ∘ |
| Exemplary 2 | ∘ | ∘ | ∘ | ∘ | ∘ | ∘ |
| Comparative 3 | ∘ | x | x | x | x | ∘ |
| Comparative 4 | x | ∘ | ∘ | ∘ | ∘ | ∘ |
| Exemplary 5 | ∘ | ∘ | ∘ | ∘ | ∘ | ∘ |
| Comparative 6 | x | ∘ | ∘ | ∘ | ∘ | ∘ |
| Comparative 7 | x | ∘ | ∘ | ∘ | ∘ | ∘ |
| Exemplary 8 | ∘ | ∘ | ∘ | ∘ | ∘ | ∘ |
| Exemplary 9 | ∘ | ∘ | ∘ | ∘ | ∘ | ∘ |
| Exemplary 10 | ∘ | ∘ | ∘ | ∘ | ∘ | ∘ |
| Comparative 11 | ∘ | ∘ | ∘ | ∘ | ∘ | x |

∘—pass;
x—fail

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A liquid composition configured to form a transparent oleophobic and hydrophobic antimicrobial coating after application and post-cure of the liquid composition on a substrate comprising:
(a) a fluorinated polymer present at an effective amount to provide oleophobicity and/or hydrophobicity post-cure of the liquid composition on the substrate;
(b) an acrylic polymer present at an effective amount to provide abrasion resistance and/or ultraviolet stability post-cure of the liquid composition on the substrate;
(c) a coupling agent present at an effective amount to disperse the fluorinated polymer and acrylic polymer in the liquid composition;
(d) an antimicrobial agent dispersed in the liquid composition present at an effective amount to reduce and/or prevent microbial growth post-cure of the liquid composition on the substrate; and
(e) an organic solvent at an effective amount to facilitate flowability of the liquid composition and/or to facilitate formation of the transparent oleophobic and hydrophobic antimicrobial coating on the substrate post-cure of the liquid composition.

2. The composition according claim 1, wherein the composition further comprises an inorganic acid present at an effective amount to facilitate curing of the liquid composition after application of the liquid composition on the substrate.

3. The composition according to claim 1, wherein the fluorinated polymer is selected from the group consisting of a fluorinated silane polymer, a perfluoro polyether siloxane polymer, and a combination thereof.

4. The composition according to claim 1, wherein the coupling agent is selected from the group consisting of a silane coupling agent with amine, alcohol, and/or ethoxy functionality.

5. The composition according to claim 1, wherein the organic solvent is selected from the group consisting of an alcohol, acetone, acetate, ketone, and a combination thereof.

6. The composition according to claim 1, wherein the antimicrobial agent is quaternary ammonium silane.

7. The composition according to claim 1, wherein the fluorinated polymer is present in the composition in an amount of 0.3 wt % to 1.5 wt % of the overall weight of the liquid composition.

8. The composition according to claim 1, wherein the coupling agent is present in the composition in an amount of 5.0 wt % to 30.0 wt % of the overall weight of the liquid composition.

9. The composition according to claim 1, wherein the acrylic polymer is present in the composition in an amount of 5.0 wt % to 25.0 wt % of the overall weight of the liquid composition.

10. The composition according to claim 1, wherein the organic solvent is present in the composition in an amount of 29.0 wt % to 85.0 wt % of the overall weight of the liquid composition.

11. The composition according to claim 1, wherein the antimicrobial agent is present in the composition in an amount of 0.5 wt % to 1.5 wt % of the overall weight of the liquid composition.

12. The composition according to claim 1, wherein the acrylic polymer is an acrylic homopolymer.

13. The composition according to claim 1, wherein the coupling agent and acrylic polymer are present in the liquid composition at a ratio ranging from 1:5 to 6:1 relative to one another.

14. The composition according to claim 1, wherein the coupling agent and fluorinated polymer are present in the liquid composition at a ratio ranging from 3.33:1 to 100:1 relative to one another.

15. The composition according to claim 1, wherein the antimicrobial agent is present in the liquid composition at a ratio ranging from 1:133 to 1:6.8 relative to a total combination of the fluorinated polymer, the coupling agent and the acrylic polymer.

16. A transparent oleophobic and hydrophobic antimicrobial coating comprising:
a fluorinated polymer;
a silane coupling agent;
an acrylic polymer; and
a quaternary ammonium silane at an effective amount to to reduce and/or prevent microbial growth on the substrate.

17. The coating according to claim 16, wherein the fluorinated polymer is selected from the group consisting of a fluorinated silane polymer, a perfluoro polyether siloxane polymer, and a combination thereof.

18. The coating according to claim 16, wherein the organic solvent is selected from the group consisting of an alcohol, acetone, acetate, ketone, and a combination thereof.

19. The coating according to claim 16, wherein the fluorinated polymer is present in the transparent oleophobic and hydrophobic coating at a concentration ranging from 0.5 wt % to 20 wt % of the overall concentration of the transparent oleophobic and hydrophobic coating.

20. The coating according to claim 16, wherein the silane coupling agent is present in the transparent oleophobic and hydrophobic coating at a concentration ranging from 20 wt % to 95 wt % of the overall concentration of the transparent oleophobic and hydrophobic coating.

21. The coating according to claim 16, wherein the acrylic polymer is present in the transparent oleophobic and hydrophobic coating at a concentration ranging from 4 wt % to 65 wt % of the overall concentration of the transparent oleophobic and hydrophobic coating.

22. The coating according to claim 16, wherein the quaternary ammonium silane is present in the transparent oleophobic and hydrophobic coating at a concentration ranging from 0.5 wt % to 13 wt % of the overall concentration of the transparent oleophobic and hydrophobic coating.

23. The coating according to claim 16, wherein the acrylic polymer is an acrylic homopolymer.

24. The coating according to claim 16, wherein the coupling agent and acrylic polymer are present in the transparent oleophobic and hydrophobic coating at a ratio ranging from 1:5 to 6:1 relative to one another.

25. The coating according to claim 16, wherein the coupling agent and fluorinated polymer are present in the transparent oleophobic and hydrophobic coating at a ratio ranging from 3.33:1 to 100:1 relative to one another.

26. The coating according to claim 16, wherein the antimicrobial agent is present in the transparent oleophobic and hydrophobic coating at a ratio ranging from 1:133 to 1:6.8 relative to a total combination of the fluorinated polymer, the coupling agent and the acrylic polymer.

27. A method comprising:
(a) applying the liquid composition of claim 1 to a substrate, and
(b) after step (a), curing the liquid composition on the substrate thereby forming a transparent oleophobic and hydrophobic antimicrobial coating on the substrate.

28. The method of claim 27, wherein the liquid composition is applied by at least one of spray coating, dip coating, roll coating, curtain coating, brush coating, or slot-die coating.

29. The method of claim 27, wherein, during step (a), the liquid composition is evenly and/or homogeneously applied to the substrate.

30. The method of claim 27, wherein the transparent oleophobic and hydrophobic antimicrobial coating is uniformly formed on the substrate.

31. The method of claim 27, wherein the transparent oleophobic and hydrophobic antimicrobial coating of step (b) comprises at least two of the fluorinated polymer, acrylic polymer, coupling agent, and antimicrobial agent homogeneously dispersed therein.

32. The method of claim 27, wherein the transparent oleophobic and hydrophobic antimicrobial coating of step (b) comprises at least three of the fluorinated polymer, acrylic polymer, coupling agent, and antimicrobial agent homogeneously dispersed therein.

33. The method of claim 27, wherein the transparent oleophobic and hydrophobic antimicrobial coating of step (b) comprises each of the fluorinated polymer, acrylic polymer, coupling agent, and antimicrobial agent homogeneously dispersed therein.

34. The method of claim 27, wherein the transparent oleophobic and hydrophobic antimicrobial coating of step (b) has a thickness of 0.1 μm to 1.5 μm

35. The method of claim 27, wherein the transparent oleophobic and hydrophobic antimicrobial coating of step (b) is fingerprint resistant and/or smudge resistant.

36. The method of claim 27, wherein the substrate is a planar substrate.

37. The method of claim 27, wherein the substrate is a rigid, planar substrate.

38. The method of claim 27, wherein the substrate comprises a transparent glass or transparent plastic.

39. The method of claim 27, wherein the substrate is transparent and the transparent oleophobic and hydrophobic antimicrobial coating of step (b), and there are no visual differences between the transparencies of the substrate and the transparent oleophobic and hydrophobic antimicrobial coating of step (b).

40. The method of claim 27, wherein the transparent oleophobic and hydrophobic antimicrobial coating of step (b) is permanently formed on the substrate.

41. An article comprising a substrate with liquid composition of claim 1 applied to the substrate.

42. The article of claim 41, wherein the substrate is a transparent glass or transparent plastic.

43. The article of claim 41, wherein the fluorinated polymer is present in the composition in an amount of 0.3 wt % to 1.5 wt % of the overall weight of the liqiud composition.

44. The article of claim 41, wherein the coupling agent is present in the composition in an amount of 5.0 wt % to 30.0 wt % of the overall weight of the liquid composition.

45. The article of claim 41, wherein the acrylic polymer is present in the composition in an amount of 5.0 wt % to 25.0 wt % of the overall weight of the liquid composition.

46. The article of claim 41, wherein the organic solvent is present in the composition in an amount of 29.0 wt % to 85.0 wt % of the overall weight of the liquid composition.

47. The article of claim 41, wherein the antimicrobial agent is present in the composition in an amount of 0.5 wt % to 1.5 wt % of the overall weight of the liquid composition.

48. The article of claim 41, wherein the coupling agent and acrylic polymer are present in the liquid composition at a ratio ranging from 1:5 to 6:1 relative to one another.

49. The article of claim 41, wherein the coupling agent and fluorinated polymer are present in the liquid composition at a ratio ranging from 3.33:1 to 100:1 relative to one another.

50. The article of claim 41, wherein the antimicrobial agent is present in the liquid composition at a ratio ranging from 1:133 to 1:6.8 relative to a total combination of the fluorinated polymer, the coupling agent and the acrylic polymer.

51. An article comprising a substrate with the transparent oleophobic and hydrophobic coating of claim 13 applied to the substrate.

52. The article of claim 51, wherein the substrate is a transparent glass or transparent plastic.

53. The article of claim 51, wherein the coupling agent and acrylic polymer are present in the transparent oleophobic and hydrophobic coating at a ratio ranging from 1:5 to 6:1 relative to one another.

54. The article of claim 51, wherein the coupling agent and fluorinated polymer are present in the transparent oleophobic and hydrophobic coating at a ratio ranging from 3.33:1 to 100:1 relative to one another.
